(19) United States
(12) Patent Application Publication
(10) Pub. No.: US 2008/0177639 A1
(43) Pub. Date: Jul. 24, 2008

(54) System and method for facilitating the retail sale of customizable products

(76) Inventors: Marc Kuppersmith, Stamford, CT (US); Chris Chiaia, Norwalk, CT (US)

Correspondence Address: James G. Coplit, Esq.;GRIMES & BATTERSBY, LLP, 488 Main Avenue, Third Floor, Norwalk, CT, 06851, US

(21) Appl. No.: 11/901,739

(22) Filed: Sep. 18, 2007

Related U.S. Application Data
(60) Provisional application No. 60/881,234, filed on Jan. 19, 2007.

(51) Int. Cl. G06F 17/30

(52) U.S. Cl. 705/27

(57) ABSTRACT

A fully automated system is provided for “virtually” creating an object having two or more variable characteristics. A user is prompted to select a value for each of these characteristics, whereupon the system accesses a database to determine the cost, on a real-time basis, for each of these selected values to thereby determine the total cost of the created object. An image of the object as created by the user is automatically provided and updated each time the user changes a value, as is the total cost. A price point match feature is also provided to allow the user to enter a target price point to thereby allow the system to create a product whose total cost is as close as possible to the target price point. The system is particularly useful in the design of jewelry.

### CROSS REFERENCES TO RELATED APPLICATIONS

This is a non-provisional patent application claiming benefit of priority of U.S. Provisional Patent Application No. 60/881,234 filed on Jan. 19, 2007 for “Mini Kiosk.”

### STATEMENT REGARDING FEDERALLY SPONSORED RESEARCH

Not Applicable

### REFERENCE TO APPENDIX

Not Applicable

### BACKGROUND OF THE INVENTION

A. Field of the Invention

The present invention relates to the retail sale of customizable items having one or more variables in the creation thereof, and more particularly to a system and method for facilitating the sale of such customizable items, and more particularly to such a system and method that is ideally suited for use on a global computer network such as the Internet, and even more particularly, to such a system that allows a user to modify variables in the customization of the retail items so as to create the desired item based on factors such as cost, size, and components. The system and method is particularly suited to the creation of jewelry, such as engagement rings and the like.

B. Description of the Prior Art

In the retail sale of certain customizable items, such as jewelry and the like, physical retail stores, TV Networks or on-line retailers cannot reasonably carry sufficient inventory to immediately supply the consumer exactly what they are looking for. In the jewelry industry, specialty and high demand items of what are commonly referred to as anniversary and eternity bands are extremely problematic for a variety of reasons. The setting of gemstones around a significant portion of the circumference (‘anniversary’) or the entire circumference (‘eternity’) of the band makes the ring virtually impossible to re-size without destroying the structural integrity of the ring and security of the stones. Furthermore, the nature of the ring makes the cost prohibitively high for retailers to carry multiple sizes, widths, etc. in order to meet the needs of a retail environment. The result is a shopping experience which leaves the consumer with very little comfort about exactly what they have purchased.

The Internet has drastically changed the retail industry and the jewelry industry in particular. Web-based retailers such as Blue Nile have forced traditional brick-and-mortar retailers—both national retail chains that address mass-market demands and many artisans focused more on quality and customization—to change their business models in order to survive. Demand for jewelry will continue to range from low-budget and mass-produced to extravagant and highly customized. For many, it makes a personal statement and has significant and often sentimental value.

### SUMMARY OF THE INVENTION

Against the foregoing background, it is a primary object of the present invention to provide an application that allows consumers or retailers to virtually create a customizable retail product.

It is another object of the present invention to provide such an application that is Internet website-based.

It is yet another object of the present invention to provide such an application that also allows consumers or retailers to design and price the customizable retail products.

It is still another object of the present invention to provide such an application that is easy to use and operate.

It is another object of the present invention to provide such an application that eliminates the need for a retailer to carry significant quantities of products.

It is another object of the present invention to provide such an application that has particular utility in the jewelry industry.

It is still another object of the present invention to provide such an application that allows a user to specify the following characteristics in designing a ring: ring type, setting type, stone type, stone shape, ring finish and ring size.

It is another object of the present invention to provide such an application that allows the user to vary a sub-set of the significant cost drivers for the items being virtually created so as to optimize certain value for a given cost.

It is yet another object of the present invention to provide such an application that provides the user with a graphical representation of the completed item.

It is still another object of the present invention to provide such an application that allows the user to create the customizable item without the need of sales assistance.

It is another object of the present invention to provide such an application that provides the user with real-time pricing of the created items.

It is but another object of the present invention to provide such an application that takes place in a single-page environment.

It is yet another object of the present invention to provide such an application that includes a “reconfigurator” that allows the user to build a product, provide a budget, and the application will reconfigure the item to suit the budget.

To the accomplishments of the foregoing objects and advantages, the present invention, in brief summary comprises a fully automated system for “virtually” creating an object having two or more variable characteristics. The system is particularly useful in the design of jewelry.

Referring specifically to the jewelry design application of the system and method of the present invention, the application provides the user with the ability to specify the following basic characteristics of a ring:

Ring type (e.g. anniversary or eternity)

Setting type (e.g. channel or prong)

Stone type (e.g. diamond, ruby)

Stone shape (e.g. round, princess)

Ring finish (e.g. plain, milgrain)

Ring size

What differentiates this application from others is that the user is given the ability to manipulate one or more of the following sub-sets of the significant cost-drivers of the custom-built ring:

Stone size

Stone count

Total carat weight

Metal type (e.g. gold, platinum)

Cost

The choices are presented to the consumer on a single, dynamic web-page, and a representative picture of the user's selections is displayed based on the chosen alternatives.

The sub-set of the cost-drivers made available to the user, or consumer, is determined by the branding partner, such as the retailer. For example, if the retailer wants to allow the user to define the metal type and price point or cost of the ring, through a pre-defined set of algorithms the application will define the size and count (and therefore carat weight) of the specified stone type. Alternatively, the user can specify the metal type and desired stone size, which will drive the required number of stones (based on ring size), the total carat weight and ultimately the price of the ring. The application then provides for the manufacturer, all of the detailed specifications of the user-designed ring, including the volume of the metal required.

The consumer can find, alter and personalize his or her piece of fine jewelry, all with or without sales assistance. The multiple configurators will allow the consumer not only the ability to see the products they are about to buy, but allow them to price adjust (by changing one or more of the attributes of the product so they will not just create something but pay a budgeted price they are comfortable with. The real time pricing will assure the retailer of maintaining a margin that is not only healthy and guaranteed but even create a high gross margin as the items can now not be “shopped” as the chances are that is not another one like it to compare it to.

The system is user friendly and does not require the ability to know CAD, computers or even what make the application work. Unlike an application such as EXEL there are not commands to master, formulas to learn or tricks to memorize. It is straight forward and easy. The best part for the consumer is that it all takes place in a single page environment so if you make an error (as with most BYOR applications) you do not have to start over 10 pages back, you simply click you needed change and the page will reset to the new adjusted item and price.

The system may also include a “reconfigurator” that allows the consumer to build a product, put in a budget and the application will reconfigure the item to suite the budget . . . no guess work no frustration.

Once the item is created, it can travel to the factory in a number of different ways, shopping cart, email, fax or any method of information sharing the business partner wishes to use.

### BRIEF DESCRIPTION OF THE DRAWINGS

The foregoing and still other objects and advantages of the present invention will be more apparent from the detailed explanation of the preferred embodiments of the invention in connection with the accompanying drawings, wherein:

FIG. 1 is a graphical representation of the landing page of the customizable product creation system of the present invention;

FIG. 2 is an illustration of the configurator of the customizable product creation system of the present invention; and

FIG. 3 is a flow chart showing the operation of the customizable product creation system of the present invention.

### DETAILED DESCRIPTION OF THE PREFERRED EMBODIMENTS

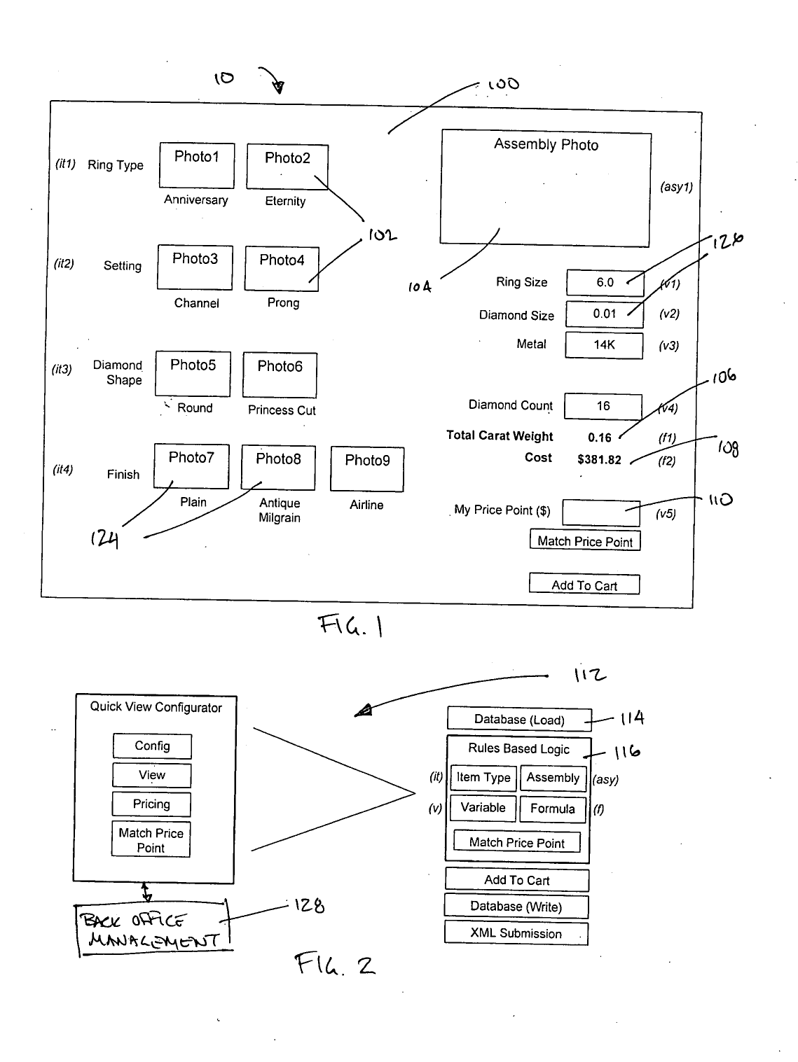

Referring to the drawings and, in particular, to FIG. 1 thereof, the customizable product creation system 10 of the present invention is provided and is referred to generally by reference numeral 10.

In the preferred embodiment, the customizable product creation system 10 is installed on an Internet website or is otherwise accessible by means of a global computer network. Access to the customizable product creation system 10 is provided by a hyperlink that resides on the partner's servers. A bridge script appends the partner identification (ID) and a return URL (URL) to the hyperlink that provides the necessary information for the customizable product creation system 10 to add items to the partner's shopping cart. After receiving the ID and the URL, the customizable product creation system 10 will display the landing page 100 within the framework on the partner's site. A sample image of the landing page 100 is illustrated in FIG. 1.

Included on the landing page 100 are two or more customizable attributes 102, such as ring type, finish, diamond size, etc. In the preferred embodiment, when first retrieved by the consumer, the customizable product creation system 10 has all attributes 102 assigned to a default value, thus displaying a completely configured ring. These attributes 102 can be assigned any value allowing the partner to predetermine what the customer first sees. This will allow the partner to guide the consumer toward designated specials or configurations based on known customer preferences.

Also included on the landing page are an image or photo 104 of the assembled product, which image 104 is created by the system based upon the specific attributes 102 selected by the user. In addition, certain calculated values 106 are also provided on the landing page 100, which calculated values 106 include the total cost 108 which is computed based upon the values of the customizable attributes 102. Also provided is a price point amount 110, which the user may provide to allow the system 10 to reconfigure the item based upon the attributes 102 selected and the price point 110 entered.

The customizable product creation system 10 can utilize off the shelf packages such as Ajax and Atlas technology to preload attribute features such as product photos and page navigation features. This technology reduces the amount of time needed to “refresh” the screen after each user selection, allowing for a faster and more dynamic user experience.

The user customization of a product using the system 10 of the present invention is controlled by a configurator 112, which is category-specific (rings, earring, etc) and bases its calculations in one case a volume based weight calculation, where the system 10 uses its source code to determine the weight of the jewelry by being able to calculate the number of cubic millimeters of metal in the jewelry. In the preferred embodiment, the system 10 knows the weight of a cubic mm of all precious metals and thus is able to determine the cost of the metal for that item and price the jewelry on the spot price of metal that day.

Some items do not need nor lend themselves to the volume based prices. The configurator 112 in those cases uses programmed information for the item, and through the code will adjust for a change of karat, metal type, finger size and widths to create the finished price. The configurator 112 also is updated with the current wholesale prices of precious diamonds on a regular basis. The similar changes apply with labor, chains and other part that go into making the finished products.

By collecting this information together in real time, and by knowing the margins of the factory, the retailer and other companies (in necessary) in the food chain, the configurator 112 is able to define the finished total cost 108 seen by the consumer. In the preferred embodiment, the system 10 also allows discounts or special prices to be applied at any time by the retailer and gives a greater profit to advertised items. This previously unavailable feature will allow the retail partner to use a “low priced” item in an ad and when the consumer sees the configurator 112 to build it their way, will expand sales and margins not seen before.

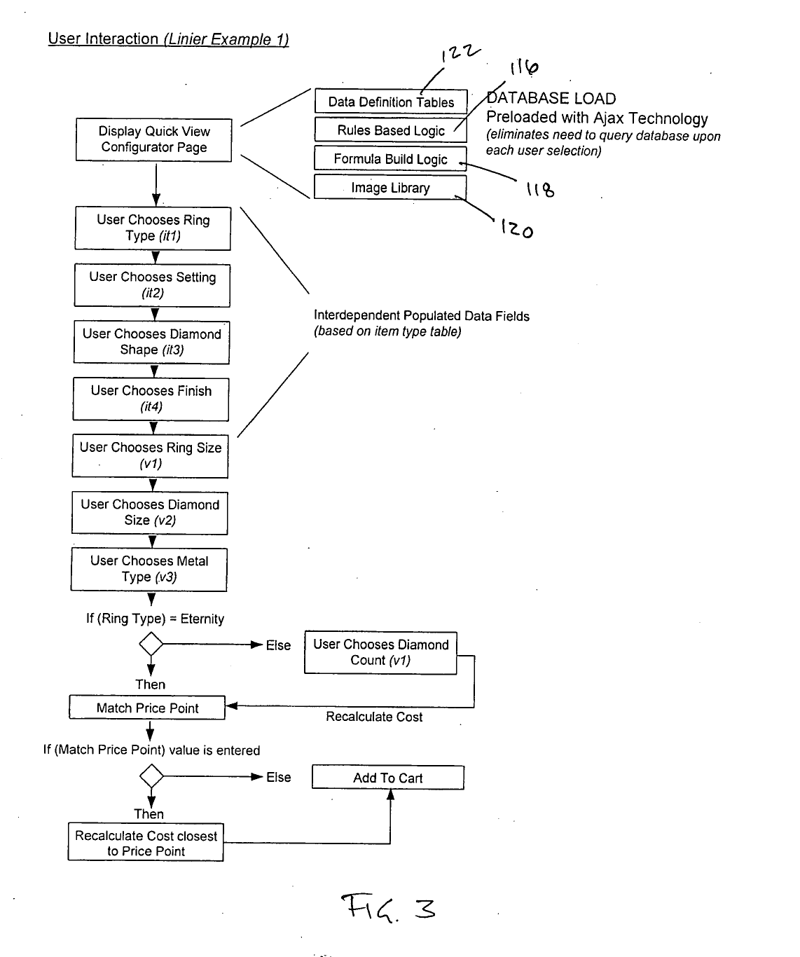

In the preferred embodiment, as illustrated in FIG. 2, the configurator 112 comprises a system that allows the user to configure the product, view the configured product, price the configured product and match the user-input price point 110. The information that the configurator 112 uses in computing the total cost 108 of the product, such as price of metal, labor costs, etc. are stored in a database 114 that is accessed by the configurator 112 on a real-time basis. The configurator 112 also utilizes a plurality of rules-based logic 116 and formula build logic 118 subroutines in its computation, including item type, assembly, variables and formulae. These subroutines 116 are also utilized in the computation of the match price point. Finally, an image library 120 may be provided including an image of each conceivable product as configured by the user.

Alternatively, a graphical subroutine may be used to display a computer graphic (CG) representation of the product.

The actual operation of the system 10 of the present invention, as controlled by the configurator and as seen by the user, is illustrated in FIG. 3. When a user first accesses the customizable product creation system 10 of the present invention by accessing the landing page 100, the configurator 112 loads the database 114, including data definition tables 122, the rules-based logic subroutines 116, the formula build logic subroutines 118 and the image library 120. The user is then given the opportunity to select the customizable attributes 102. As illustrated in FIG. 3, the product being created is a diamond ring; therefore, the user is prompted to select the ring type, setting, diamond shape, finish, ring size, diamond size and metal type. If the type of ring selected by the user is an eternity band, then the user is also prompted to enter the diamond count.

Based upon the customizable attributes 102 selected by the user, the configurator 112 searches image library 120 to display an image of the product corresponding to these attributes 102, and accesses the subroutines 116, 122 and data definition tables 122 to compute and display the total cost 108 of the product created by the user. The system will constantly change to retail price so the consumer will always be aware of the results their customizations are making. They will see the photo and the price change at the same time. The system then checks to determine whether a price point 110 has been entered by the user, in which event the configurator 112 will reset the value of one or more of the attributes 102 so as to create an item whose total cost 108 is as close as possible to the price point 110 entered by the user.

It should be appreciated that the customizable attributes 102 may be selected by the user in a variety of ways, such as two or more buttons or icons 124, or as a user-input value 126. The configurator below is typical of the process. The consumer will simply use their mouse or key pad to change these attributes, such as style, finish, diamond shape, diamond size, finger size, and metal type.

The system 10 also includes a completed back office management tool 128. This tool allows the business partner to adjust the prices, offering, margins and selections they wish to show. It also provides an order tracking system to follow the progress of the item through the process of manufacturing and shipping.

Having thus described the invention with particular reference to the preferred forms thereof, it will be obvious that various changes and modifications can be made therein without departing from the spirit and scope of the present invention as defined by the appended claims.

Wherefore I claim:

1. A system for facilitating the creation in a virtual environment of products having variable characteristics to thereby eliminate the need to carry physical inventory in a retail environment, said system comprising:
a computerized database having multiple variables identifying those characteristics of said products that determine the value of said products;
means for a user to select a particular value for said variables; and
means for computing the total cost of said product based on said input variables and configuring a virtual product.

2. The system of claim 1, further including means for generating and displaying a sample image of said product.

3. The system of claim 1, further including means for purchasing said virtual product.

4. The system of claim 1, further including means for automatically downloading the values of component elements of said product.

5. The system of claim 1, wherein said product comprises jewelry, and said variables are selected from the group consisting of ring size, ring style, stone shape, stone pattern, stone type, number of stones, stone size, stone quality and metal type.

6. A method for facilitating the creation in a virtual environment of products having variable characteristics to thereby eliminate the need to carry physical inventory in a retail environment, said method comprising the steps of:
providing a computerized database having multiple variables identifying those characteristics of said products that determine the value of said products;
selecting a particular value for said variables;
automatically determining the cost of said component parts of said products;
computing the value of said product based on said input variables and the cost of said component parts; and
configuring a virtual product.
